(19) United States
(12) Patent Application Publication
(10) Pub. No.: US 2023/0124490 A1
(43) Pub. Date: Apr. 20, 2023

(54) COURSE PREDICTION DEVICE

(71) Applicant: Mitsubishi Electric Corporation, Tokyo (JP)

(72) Inventors: Kyosuke KONISHI, Tokyo (JP); Takuji Morimoto, Tokyo (JP); Taku Umeda, Tokyo (JP); Tadahiko Urano, Tokyo (JP)

(73) Assignee: Mitsubishi Electric Corporation, Tokyo (JP)

(21) Appl. No.: 17/886,066

(22) Filed: Aug. 11, 2022

(30) Foreign Application Priority Data
Oct. 18, 2021 (JP) 2021-170080

(51) Int. Cl. B60W 30/09; B60W 30/095; B60W 30/16; B60W 30/18; B60W 40/04; B60W 50/00

(52) U.S. Cl. CPC B60W 30/09; B60W 30/0956; B60W 30/16; B60W 30/18163; B60W 40/04; B60W 50/0097; B60W 2552/53; B60W 2554/4041; B60W 2554/4045; B60W 2554/80

(57) ABSTRACT

There is provided a course prediction device which includes: a vehicle information detection unit for detecting positions and velocities of multiple vehicles; a road information acquisition unit for acquiring road information indicative of positions of lanes in a road on which the vehicles are traveling; a predicted course calculation unit for calculating a predicted course of each vehicle that is a future traveling course thereof; a collision-expected vehicle extraction unit for extracting the front vehicle and the rear vehicle on the same lane that may possibly collide with each other, on the basis of the road information and the predicted courses; an avoidance-action vehicle prediction unit for predicting which one of the front and rear vehicles is an avoidance action vehicle that will take a collision avoidance action; and an avoidance course calculation unit for calculating a collision avoidance course of the avoidance action vehicle.

### TECHNICAL FIELD

The present application relates to a course prediction device.

### BACKGROUND

During travel of a vehicle on a road, it is important to recognize and predict the traveling state of another vehicle nearby said vehicle. Such a technique is known in which the position, velocity, etc. of the nearby vehicle are detected on the basis of sensor information, to thereby predict an action such as approach, lane change or the like, of that vehicle. As an exemplary conventional art, a technique is disclosed in which, with respect to two vehicles that are other than a host vehicle and traveling in a lane adjacent to a traveling lane in which the host vehicle is traveling, a possibility that the vehicle on the rear side in the traveling direction of the respective vehicles will change the lane to the traveling lane of the host vehicle, is predicted (for example, Patent Document 1).

### CITATION LIST

### Patent Literature

Patent Document 1: Japanese Patent No. 6494121

The technique disclosed in Patent Document 1 describes how to predict a vehicle action when there is a possibility of collision between two vehicles—the front vehicle and the rear vehicle—which are traveling in the same lane. Out of these two vehicles, the rear vehicle which is traveling on the rear side is assumed to take a collision avoidance action, so that the action of the rear vehicle is predicted. However, actually, such a situation may also arise in which, out of these two vehicles, the front vehicle which is traveling on the front side takes a collision avoidance action in response to approach of the rear vehicle. According to the technique described in Patent Document 1, there is a problem that it is not possible to predict a situation in which, out of two vehicles which are traveling in the same lane, the front vehicle takes a collision avoidance action.

### SUMMARY

This application has been made to solve the problem as described above. An object thereof is to provide a course prediction device by which, with respect to a front vehicle and a rear vehicle which are traveling in the same lane and which may possibly collide with each other, whether the front vehicle or the rear vehicle will take a collision avoidance action is predicted and then a future traveling course of that vehicle is calculated, so that the prediction accuracy of the traveling states of the nearby vehicles can be improved.

### Solution to Problem

A course prediction device according to this application comprises:

a vehicle information detection unit for detecting positions and velocities of multiple vehicles;

a road information acquisition unit for acquiring road information indicative of positions of lanes in a road on which the vehicles are traveling;

a predicted course calculation unit for calculating a predicted course of each of the vehicles that is a future traveling course thereof;

a collision-expected vehicle extraction unit for extracting, from the vehicles, a front vehicle and a rear vehicle on a same lane in said lanes that may possibly collide with each other, on a basis of the road information acquired by the road information acquisition unit and the predicted courses calculated by the predicted course calculation unit;

an avoidance-action vehicle prediction unit for predicting which one of the front and rear vehicles extracted by the collision-expected vehicle extraction unit is an avoidance action vehicle that will take a collision avoidance action, on the basis of the road information and the predicted courses; and

an avoidance course calculation unit for calculating a collision avoidance course of the avoidance action vehicle predicted by the avoidance-action vehicle prediction unit.

### Advantageous Effects

By the course prediction device according to this application, with respect to the front vehicle and the rear vehicle that are traveling in the same lane and that may possibly collide with each other, it is possible to predict whether the front vehicle or the rear vehicle will take a collision avoidance action, and to calculate a future traveling course of that vehicle. This makes it possible to improve the prediction accuracy of the traveling states of the nearby vehicles.

### BRIEF DESCRIPTION OF DRAWINGS

FIG. 1 is a configuration diagram of a course prediction device according to Embodiment 1.

FIG. 2 is a hardware configuration diagram of the course prediction device according to Embodiment 1.

FIG. 3 is a diagram for illustrating a possibility of collision between vehicles, according to Embodiment 1.

FIG. 4 is a diagram showing a collision avoidance course of a rear vehicle, according to Embodiment 1.

FIG. 5 is a diagram showing a collision avoidance course of a front vehicle, according to Embodiment 1.

FIG. 6 is a vehicle location diagram for illustrating a provability of straight movement and a provability of lane change about a rear vehicle, according to Embodiment 1.

FIG. 7 is a vehicle location diagram for illustrating a provability of straight movement and a provability of lane change about a front vehicle, according to Embodiment 1.

FIG. 8 is a flowchart showing operations of the course prediction device according to Embodiment 1.

FIG. 9 is a flowchart showing a first example of operations of an avoidance-action vehicle prediction unit in the course prediction device according to Embodiment 1.

FIG. 10 is a diagram showing a collision avoidance course of a vehicle in a rightmost lane, according to Embodiment 1.

FIG. 11 is a flowchart showing a second example of operations of the avoidance-action vehicle prediction unit in the course prediction device according to Embodiment 1.

FIG. 12 is a diagram showing a collision avoidance course of a vehicle in a leftmost lane, according to Embodiment 1.

FIG. 13 is a diagram showing a collision avoidance course of a vehicle in a center lane, according to Embodiment 1.

FIG. 14 is a flowchart showing a first example of operations of an avoidance-action vehicle prediction unit in a course prediction device according to Embodiment 2.

FIG. 15 is a first diagram showing a collision avoidance course of a vehicle, according to Embodiment 2.

FIG. 16 is a flowchart showing a second example of operations of the avoidance-action vehicle prediction unit in the course prediction device according to Embodiment 2.

FIG. 17 is a second diagram showing a collision avoidance course of a vehicle, according to Embodiment 2.

FIG. 18 is a third diagram showing a collision avoidance course of a vehicle, according to Embodiment 2.

FIG. 19 is a fourth diagram showing a collision avoidance course of a vehicle, according to Embodiment 2.

FIG. 20 is a configuration diagram of a course prediction device according to Embodiment 3.

FIG. 21 is a flowchart showing an example of operations of an avoidance-action vehicle prediction unit in the course prediction device according to Embodiment 3.

FIG. 22 is a diagram for illustrating a possibility of collision caused by a collision avoidance course of a vehicle, according to Embodiment 3.

FIG. 23 is a diagram showing a collision avoidance course of a vehicle, according to Embodiment 3.

FIG. 24 is a flowchart showing an example of operations of an avoidance-action vehicle prediction unit in a course prediction device according to Embodiment 4.

### DESCRIPTION OF EMBODIMENTS

### 1. Embodiment 1

<Configuration of Course Prediction Device>

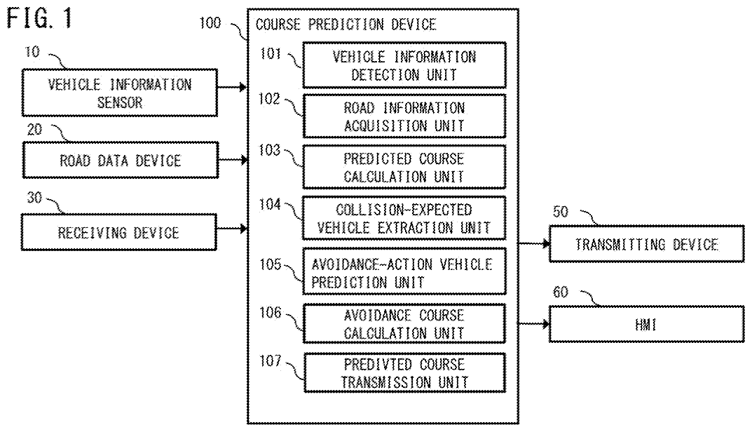

FIG. 1 is a configuration diagram showing functional blocks of a course prediction device 100 according to Embodiment 1. The course prediction device 100 is mounted on a vehicle, and recognizes and predicts traveling states of the other nearby vehicles. The course prediction device 100 receives signals from a vehicle information sensor 10, a road data device 20 and a receiving device 30. Further, the course prediction device 100 transmits signals to a transmitting device 50 and an HMI (Human Machine Interface) 60 that are mounted on the vehicle.

The vehicle information sensor 10 outputs the current states (positions, velocities, etc.) of the host vehicle and the other vehicles. The vehicle information sensor 10 may be that which includes a group of sensors incorporated in the host vehicle, such as, a vehicle speed sensor, an acceleration sensor, a yaw-rate sensor (angular acceleration sensor) and the like. The vehicle information sensor 10 may include as its configuration element, a GPS (Global Positioning System) or like device capable of recognizing the position of the host vehicle. Further, the vehicle information sensor 10 may be that which includes as its configuration element, a sensor such as a camera, a radar, an LiDAR (Light Detection And Ranging) or the like, mounted on the host vehicle, and thus can detect the states of other vehicles located outside. Furthermore, the vehicle information sensor 10 may have a capability of detecting the attribution of each of the other vehicles (identification of a compact vehicle, a medium-size vehicle, a large-size vehicle, an emergency vehicle or the like).

The road data device 20 has road information and can provide road information around the host vehicle. The road information includes the position and the configuration of the road, the number of traffic lanes, the configuration of these lanes, and the like. Although the road information device may be a device which is mounted on the vehicle and stores the road information in a storage medium, it may be a device for providing road information, whenever necessary, from a data device established outside the host vehicle.

Using the receiving device 30, the course prediction device 100 receives data from another device in the host vehicle or a device outside the host vehicle. The data to be received may include latest road data and information of a road condition, such as, traffic jam, construction work, speed limitation, traffic prohibition, occurrence of abnormal situation, approach of emergency vehicle, or the like. Further, the course prediction device may receive information detected by a vehicle information sensor of the other vehicle and/or information related to a vehicle-traveling state obtained by a vehicle information sensor provided at a road.

The transmitting device 50 transmits data from the course prediction device 100 to another device in the host vehicle or a device outside the host vehicle. Transmission information to be transmitted by the transmitting device 50 may include a predicted course or a collision avoidance course that is a future traveling course of any one of the host vehicle and the other vehicles. Further, the transmission information to be transmitted by the transmitting device 50 may include intermediate information such as information of an avoidance action vehicle predicted by the course prediction device 100.

<Functional Blocks of Course Prediction Device>

Seven functional blocks are provided in the course prediction device 100. The course prediction device 100 includes a vehicle information detection unit 101, a road information acquisition unit 102, a predicted course calculation unit 103, a collision-expected vehicle extraction unit 104, an avoidance-action vehicle prediction unit 105, an avoidance course calculation unit 106 and a predicted course transmission unit 107.

The vehicle information detection unit 101 detects the current states (positions, velocities, etc.) of the host vehicle and the other vehicles, on the basis of signals received from the vehicle information sensor 10 or the receiving device 30, or both of them. The states of the host vehicle and the other vehicles may include the acceleration rates and the attributions of these vehicles, other than the positions and velocities thereof. Here, the velocity may be calculated from a variation amount of the position. The acceleration rate may be calculated from a variation amount of the velocity. Further, the velocity may be calculated from acceleration-rate integration. The position may be calculated from velocity integration.

The road information acquisition unit 102 acquires road information around the host vehicle from the road data device 20. The road information to be acquired by the road information acquisition unit 102 may include information of a road condition, such as, traffic jam, construction work, speed limitation, traffic prohibition, occurrence of abnormal situation, approach of emergency vehicle, or the like, that is provided from the receiving device 30, other than the position and the configuration of the road, the number of traffic lanes, configurations of these lanes, and the like.

The predicted course calculation unit 103 calculates an acceleration-rate keeping course of each of the vehicles, from the current states of the host vehicle and the other vehicles detected by the vehicle information detection unit 101, and the road information acquired by the road information acquisition unit 102. The acceleration-rate keeping course is a course estimated on the assumption that the vehicle keeps its traveling lane at its current acceleration rate, and may also be referred to as a predicted course.

The predicted course is provided with a position, a velocity and an acceleration rate of the vehicle at a time later than the current time, and a possibility index of that predicted course. The possibility index is an index indicative of a level of possibility that the action represented by the predicted course will be actually taken, and is indicated by a value of not less than 0 and not more than 1. The predicted course and the possibility index of each of the vehicles are together referred to as a predicted result of that vehicle. In order to calculate the predicted course, such an existing technique may be employed in which respective motions in a direction of a passage along the road and in a direction perpendicular to the passage are predicted. For example, a technique described in Patent Document of International Patent Application Publication No. 2020/148894 may be employed.

The collision-expected vehicle extraction unit 104 receives the predicted results calculated by the predicted course calculation unit 103 and the avoidance course calculation unit 106. Then, on the basis of the predicted results thus received, the collision-expected vehicle extraction unit extracts a pair of front and rear vehicles which are highly likely to collide with each other at a time later than the current time and on the same lane. Hereinafter, the pair of the front vehicle and the rear vehicle extracted here will be referred to as a possibly-colliding pair.

On the basis of the predicted results about the possibly-colliding pair and the predicted results about the other vehicles, the avoidance-action vehicle prediction unit 105 predicts which one of the front and rear vehicles will take a collision avoidance action.

The avoidance course calculation unit 106 calculates the collision avoidance course about the avoidance action vehicle that will take a collision avoidance action, and the possibility index of that collision avoidance course. The collision avoidance course and the possibility index are together referred to as a predicted result of the avoidance action vehicle. When the rear vehicle in the possibly-colliding pair is the avoidance action vehicle, “a course for changing the lane in order to overtake the front vehicle” (lane change course) or “a course for increasing, by deceleration, an inter-vehicle distance to the front vehicle” (deceleration course), is given as the collision avoidance course. Further, when the front vehicle is the avoidance action vehicle, “a course for changing the lane in order to give way to the rear vehicle” (lane change course) or “a course for increasing, by acceleration, an inter-vehicle distance to the rear vehicle” (acceleration course), is given as the collision avoidance course.

From the predicted course transmission unit 107, such a content is outputted that is obtained from modifying the predicted results calculated by the predicted course calculation unit 103, on the basis of the predicted result calculated by the avoidance course calculation unit 106. The content outputted by the predicted course transmission unit 107 is transferred to the transmitting device 50, so that its data is transmitted to the other device in the host vehicle or the device outside the host vehicle.

<Hardware Configuration of Course Prediction Device>

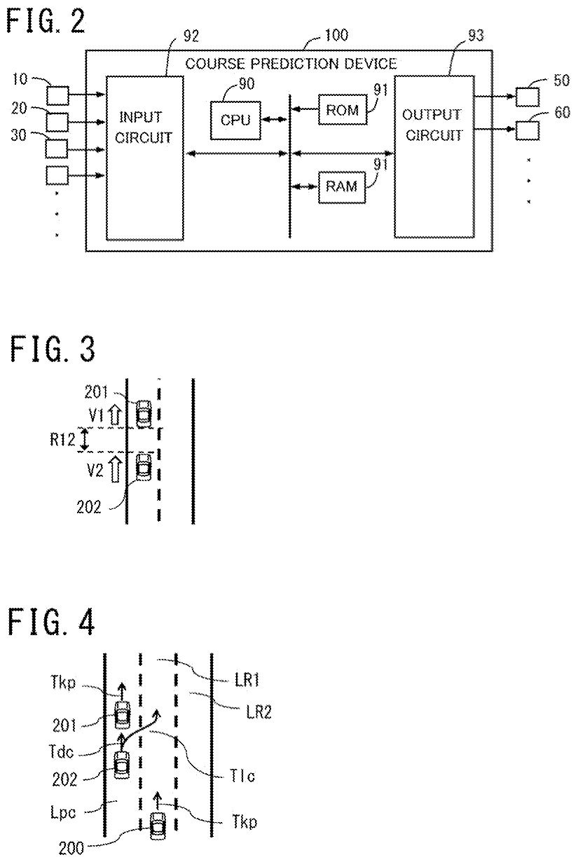

FIG. 2 is a hardware configuration diagram of the course prediction device 100. In this Embodiment, the course prediction device 100 is an electronic control device for recognizing and predicting the traveling states of the other nearby vehicles. The respective functions of the course prediction device 100 are implemented by a processing circuit included in the course prediction device 100. Specifically, the course prediction device 100 includes as the processing circuit: an arithmetic processing device 90 (computer) such as a CPU (Central Processing Unit) or the like; storage devices 91 for performing data transactions with the arithmetic processing device 90; an input circuit 92 for inputting external signals to the arithmetic processing device 90; an output circuit 93 for externally outputting signals from the arithmetic processing device 90; and the like.

As the arithmetic processing device 90, there may be included an ASIC (Application Specific Integrated Circuit), an IC (Integrated Circuit), a DSP (Digital Signal Processor), an FPGA (Field Programmable Gate Array), any one of a variety of logic circuits, any one of a variety of signal processing circuits, or the like. Further, multiple arithmetic processing devices 90 of the same type or different types may be included so that the respective parts of processing are executed in a shared manner. As the storage devices 91, there are included a RAM (Random Access Memory) that is configured to allow reading and writing of data by the arithmetic processing device 90, a ROM (Read Only Memory) that is configured to allow reading of data by the arithmetic processing device 90, and the like. As the storage device 91, a non-volatile or volatile semiconductor memory, such as a flash memory, an EPROM, an EEPROM or the like; a magnetic disc; a flexible disc; an optical disc; a compact disc; a mini disc; a DVD; or the like, may be used. Output signals of a variety of sensors and switches including the vehicle information sensor 10, the road data device 20 and the receiving device 30, and further a communication line, are connected to the input circuit 92. Accordingly, the input circuit includes A-D convertors and a communication circuit for inputting the output signals from these sensors and switches, and communication information, etc., to the arithmetic processing device 90. The output circuit 93 includes a driver circuit, a communication circuit and the like for outputting control signals from the arithmetic processing device 90 to the transmitting device 50 and a device including the HMI 60.

The respective functions provided by the course prediction device 100 are implemented in such a manner that the arithmetic processing device 90 executes software (programs) stored in the storage device 91 such as the ROM or the like, to thereby cooperate with the other hardware in the course prediction device 100, such as the other storage device 91, the input circuit 92, the output circuit 93, etc. Note that the set data of threshold values, determination values and the like to be used by the course prediction device 100 is stored, as a part of the software (programs), in the storage device 91 such as the ROM or the like. Although each of the functions that the course prediction device 100 has, may be established by a software module, it may be established by a combination of software and hardware.

<Extraction of Collision-Expected Vehicles>

FIG. 3 is a diagram for illustrating a possibility of collision between vehicles, according to Embodiment 1. In FIG. 3, two vehicles—a front vehicle 201 and a rear vehicle 202—traveling in the same lane are shown.

A possibility that the front vehicle 201 and the rear vehicle 202 will collide with each other may be calculated on the basis of an inter-vehicle distance R12 and an approaching velocity ΔV12 therebetween. The approaching velocity ΔV12 corresponds to a difference between a velocity V2 of the rear vehicle 202 and a velocity V1 of the front vehicle 201, so that it can be calculated according to a formula of ΔV12=V2−V1. The possibility of collision between these vehicles may be calculated from a ratio between the approaching velocity ΔV12 and the inter-vehicle distance R12. A value resulting from dividing the approaching velocity ΔV12 by the inter-vehicle distance R12 may be defined as a collision probability Pc (Pc=ΔV12/R12). In that case, the collision probability Pc represents an inverse of a period of time until the two vehicles make contact with each other.

When the inter-vehicle distance R12 is 100 m and the approaching velocity ΔV12 is 1 m/s, the front vehicle 201 and the rear vehicle 202 will make contact with each other after 100 seconds. The velocity of 1 m/s is equal to 3.6 Km/h and is thus nearly equal to the human walking speed. The front vehicle 201 and the rear vehicle 202 may be determined to possibly collide with each other and thus may be extracted as a possibly-colliding pair, when the collision probability Pc is a predetermined value (for example, 1/100) or more. “Collision Probability Pc=1” means that a probability that the vehicles will make contact with each other after 1 second is 1.0 (100%).

With respect to the front vehicle 201 and the rear vehicle 202 shown in FIG. 3, when the collision probability Pc is a predetermined value or less, these vehicles are not deemed as a possibly-colliding pair. In that case, like another vehicle, the front vehicle 201 and the rear vehicle 202 will travel each in an acceleration-rate keeping course Tkp. The possibility index of this predicted course is given as a fixed value (for example, 1). When there is no possibly-colliding pair, the collision-expected vehicle extraction unit 104 determines that collision expected vehicles are not present.

The collision-expected vehicle extraction unit 104 confirms the inter-vehicle distance and the approaching velocity with respect to every two vehicles nearby the host vehicle which are traveling on the same lane, to thereby extract vehicles whose collision probability Pc is a predetermined value or more, as a possibly-colliding pair. The collision-expected vehicle extraction unit 104 may line up the possibly-colliding pairs in descending order of the collision probability Pc, to thereby evaluate the collision-avoidance courses of the possibly-colliding pairs, in this order.

The vehicles that form a possibly-colliding pair are not limited to vehicles which are other than a host vehicle 200 and are traveling ahead thereof. Any two vehicles which are successively traveling in the same lane and on the rear side or a lateral side of the host vehicle 200, may be a possibly-colliding pair if they are highly likely to collide with each other. Further, the possibly-colliding pair is not limited to two vehicles other than the host vehicle. When the host vehicle and another vehicle are successively traveling in the same lane, these vehicles may be extracted as a possibly-colliding pair if they are highly likely to collide with each other.

How to evaluate the possibility of collision does not have to be limited to the above method using the collision probability. In order evaluate the possibility of collision, any one of a variety of existing techniques as represented by a technique described in Patent Document of International Patent Application Publication No. 2015/156097 may be employed.

<Prediction of Avoidance Action Vehicle>

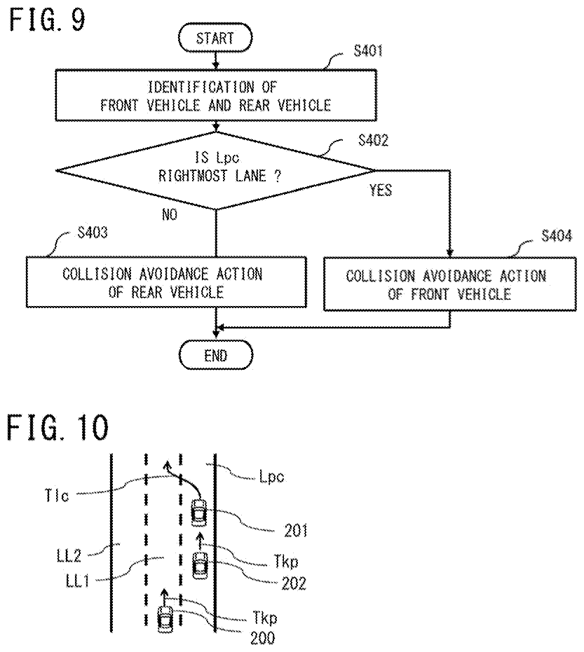

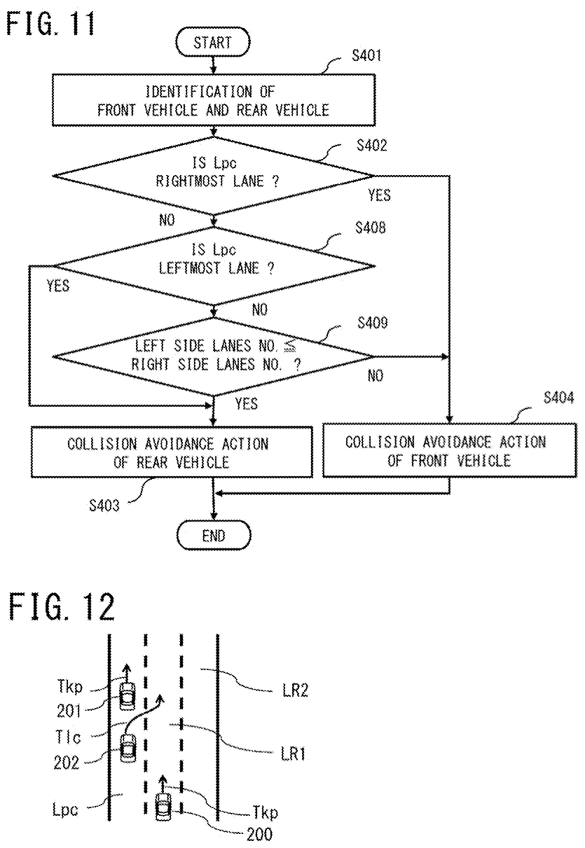

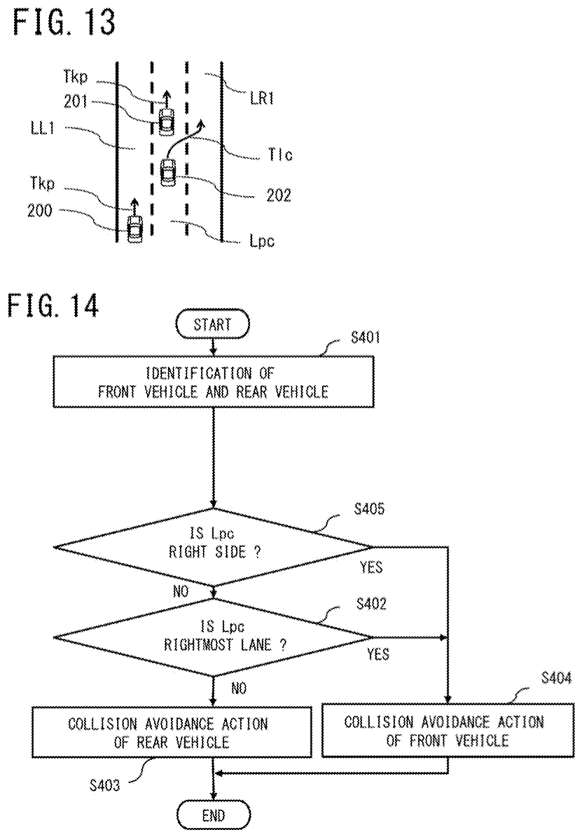

With respect to the possibly-colliding pair, the avoidance-action vehicle prediction unit 105 examines and predicts whether the front vehicle 201 or the rear vehicle 202 will take a collision avoidance action. How to predict the avoidance action vehicle will be described later using the flowcharts of FIG. 9 and FIG. 11 and the diagrams of FIG. 10, FIG. 12 and FIG. 13 in which collision avoidance courses of vehicles are shown.

<Variations of Collision Avoidance Courses>

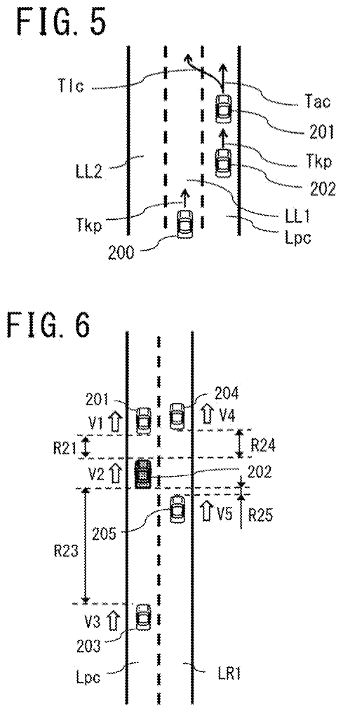

FIG. 4 is a diagram showing a collision avoidance course of the rear vehicle 202, according to Embodiment 1. FIG. 5 is a diagram showing a collision avoidance course of the front vehicle 201, according to Embodiment 1.

The avoidance course calculation unit 106 calculates a collision avoidance course of the vehicle which is predicted by the avoidance-action vehicle prediction unit 105 to take a collision avoidance action. In FIG. 4, a collision avoidance course is shown in the case where, out of the front vehicle 201 and the rear vehicle 202 as the possibly-colliding pair, the rear vehicle 202 is the avoidance action vehicle. A lane in which the possibly-colliding pair are traveling is shown as a collision expected lane Lpc. A lane in which the host vehicle 200 is traveling is a right lane LR1 on the immediate right side of the collision expected lane Lpc. In FIG. 4, a second right lane LR2 is shown on the immediate right side of the right lane LR1.

A case will be described where the rear vehicle 202 takes a collision avoidance action for avoiding collision with the front vehicle 201 which is traveling at a low velocity. The rear vehicle 202 avoids the collision by selecting either a lane change course Tlc that is “a course for changing the lane in order to overtake the front vehicle”, or a deceleration course Tdc that is “a course for increasing, by deceleration, an inter-vehicle distance to the front vehicle”. For each of these two collision avoidance courses, the easiness of selection is calculated as a possibility index. The vehicles except for the rear vehicle 202 that is the vehicle of taking a collision avoidance action, will all travel in their respective acceleration-rate keeping courses Tkp.

In FIG. 5, a collision avoidance course is shown in the case where, out of the front vehicle 201 and the rear vehicle 202 as the possibly-colliding pair, the front vehicle 201 is the avoidance action vehicle. A lane in which the possibly-colliding pair are traveling is shown as a collision expected lane Lpc. A lane in which the host vehicle 200 is traveling is a left lane LL1 on the immediate left side of the collision expected lane Lpc. In FIG. 5, a second left lane LL2 is shown on the immediate left side of the left lane LL1.

A case will be described where the front vehicle 201 takes a collision avoidance action for avoiding collision with the rear vehicle 202 which is traveling at a high velocity. The front vehicle 201 avoids the collision by selecting either a lane change course Tlc that is “a course for changing the lane in order to give way to the rear vehicle”, or an acceleration course Tac that is “a course for increasing, by acceleration, an inter-vehicle distance to the rear vehicle”. For each of these two collision avoidance courses, the easiness of selection is calculated as a possibility index. The vehicles except for the front vehicle 201 that is the vehicle of taking a collision avoidance action, will all travel in their respective acceleration-rate keeping courses Tkp.

<Selection of Collision Avoidance Course>

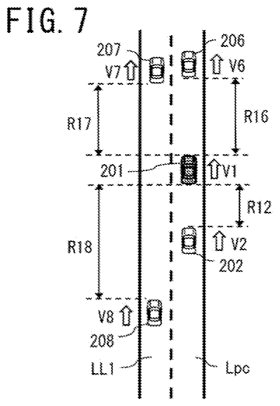

FIG. 6 is a vehicle location diagram for illustrating a provability of straight movement and a provability of lane change about the rear vehicle 202, according to Embodiment 1. FIG. 7 is a vehicle location diagram for illustrating a provability of straight movement and a provability of lane change about the front vehicle 201, according to Embodiment 1.

<Collision Avoidance Course of Rear Vehicle>

For a vehicle which is predicted by the avoidance-action vehicle prediction unit 105 to take a collision avoidance action, what course is to be taken as the collision avoidance course is calculated by the avoidance course calculation unit 106. In FIG. 6, a case is shown where the rear vehicle 202 is predicted to take a collision avoidance action. The rear vehicle 202 that will take a collision avoidance action is indicated by hatching.

In the collision expected lane Lpc in which the front vehicle 201 and the rear vehicle 202 as the possibly-colliding pair are traveling, a following vehicle 203 is shown behind the rear vehicle 202. In a right lane LR1 on the immediate right side of the collision expected lane Lpc, a leading vehicle 204 and a following vehicle 205 are shown ahead of and behind the rear vehicle 202, respectively. Further, there are shown: a velocity V1 of the front vehicle 201; a velocity V2 of the rear vehicle 202; velocities V3, V5 of the following vehicles 203, 205; a velocity V4 of the leading vehicle 204; and inter-vehicle distances R21, R23, R24, R25.

An approaching velocity ΔV21 between the rear vehicle 202 and the front vehicle 201 is given as ΔV21=V2−V1. An approaching velocity ΔV23 between the rear vehicle 202 and the following vehicle 203 is given as ΔV23=V3−V2. An approaching velocity ΔV24 between the rear vehicle 202 and the leading vehicle 204 with respect to the traveling direction is given as ΔV24=V2−V4. An approaching velocity ΔV25 between the rear vehicle 202 and the following vehicle 205 with respect to the traveling direction is given as ΔV25=V5−V2.

Consideration will be made on the collision probability Pc1 in the case where the rear vehicle 202 takes, as a collision avoidance course, the deceleration course that is “a course for increasing, by deceleration, an inter-vehicle distance to the front vehicle”. When the rear vehicle 202 keeps traveling in the collision expected lane Lpc, the probability of collision with the front vehicle 201 is ΔV21/R21. When the rear vehicle 202 keeps traveling in the collision expected lane Lpc, the probability of collision with the following vehicle 203 is ΔV23/R23. Thus, when the rear vehicle 202 keeps traveling in the collision expected lane Lpc, the collision probability Pc1 can be calculated as a sum of the above probabilities. Instead, the collision probability Pc1 may be calculated in such a manner that the higher one is selected from these probabilities.

Consideration will be made on a collision probability Pc2 in the case where the rear vehicle 202 takes, as a collision avoidance course, the lane change course that is “a course for changing the lane in order to overtake the front vehicle”. When the rear vehicle 202 has changed the lane to the right lane LR1, the probability of collision with the leading vehicle 204 is ΔV24/R24. When the rear vehicle 202 has changed the lane to the right lane LR1, the probability of collision with the following vehicle 205 is ΔV25/R25. Thus, when the rear vehicle 202 has changed the lane to the right lane LR1, the collision probability Pc2 can be calculated as a sum of the above probabilities. Instead, the collision probability Pc2 may be calculated in such a manner that the higher one is selected from these probabilities.

Accordingly, the collision probability Pc1 of the rear vehicle 202 in the case of taking the deceleration course, and the collision probability Pc2 of the rear vehicle 202 in the case of taking the lane change course can be calculated by a following formula (1).

$$\begin{matrix}[ Mathematical 1 ] & \\ \{ \begin{matrix}Pc 1 = \frac{Δ V 21}{R 21} + \frac{Δ V 23}{R 23} \\ Pc 2 = \frac{Δ V 24}{R 24} + \frac{Δ V 25}{R 25} \\ where , \\ Δ V 21 = V 2 - V 1 , Δ V 23 = V 3 - V 2 , \\ Δ V 24 = V 2 - V 4 and Δ V 25 = V 5 - V 2\end{matrix} & ( 1 )\end{matrix}$$

For each of the collision probability Pc1 in the case of taking the deceleration course and the collision probability Pc2 in the case of taking the lane change course, a possibility index may be calculated on the basis of an inverse thereof. From the inverses of the collision probability Pc1 and the collision probability Pc2, a deceleration course possibility Pp1 that is a possibility of taking the deceleration course and a lane-change course possibility Pp2 that is a possibility of taking the lane change course, may be calculated. The relationships among them are represented by a following formula (2).

$$\begin{matrix}[ Mathematical 2 ] & \\ Pp 1 : Pp 2 = \frac{1}{P c 1} : \frac{1}{P c 2} & ( 2 )\end{matrix}$$

The deceleration course possibility Pp1 and the lane-change course possibility Pp2 are each a possibility index having a value of not less than 0 and not more than 1, and can be calculated by a following formula (3).

$$\begin{matrix}[ Mathematical 3 ] & \\ \{ \begin{matrix}Pp 1 = \frac{Pc 2}{Pc 1 + Pc 2} \\ Pp 2 = \frac{Pc 1}{Pc 1 + Pc 2}\end{matrix} & ( 3 )\end{matrix}$$

It can be determined that the rear vehicle 202 will take a collision avoidance course according to either one of the deceleration course possibility Pp1 and the lane-change course possibility Pp2 having a possibility index higher than the other. In this manner, the avoidance course calculation unit 106 can calculate the collision avoidance course.

In this regard, there is a case where an approaching velocity ΔV to each target vehicle has a value of less than 0. When the approaching velocity ΔV has a negative value, it is meant that the distance to the target vehicle is increasing. Here, a restriction is applied to the value that the approaching speed ΔV has, assuming that no trouble occurs thereby in calculation. Namely, calculation is performed in such a manner that the approaching velocity is restricted by a maximum value and a minimum value as 0.1 [m/s]≤ΔV≤100 [m/s]. Further, a restriction is applied to the value that the inter-vehicle distance R has, assuming that no trouble occurs thereby in calculation. Namely, calculation is performed in such a manner that the inter-vehicle distance is restricted by a maximum value and a minimum value as 0.1 [m]≤R≤1000 [m]. (“ΔV” and “R” are not illustrated)

When one of the leading vehicle 204 and the following vehicles 203, 205 is absent, calculation for that vehicle is performed on the assumption of ΔV=0.1 [m/s] and R=1000 [m]. Accordingly, the influence weight of the target vehicle on the collision probability Pc is 0.0001 and thus, it is substantially not required to give consideration to a possibility of collision with the target vehicle.

In addition, with respect to the collision avoidance course of the rear vehicle 202, it is conceivable that the rear vehicle 202 is likely to stay in the currently-traveling collision expected lane Lpc and thus to give more priority to traveling in the same lane than to lane change. In this case, a straight movement priority γ may be defined (0≤γ≤1). With the addition of the straight movement priority γ, the deceleration course possibility Pp1 and the lane-change course possibility Pp2 of the rear vehicle 202 can be calculated as represented by a following formula (4).

$$\begin{matrix}[ Mathematical 4 ] & \\ \{ \begin{matrix}Pp 1 = \frac{Pc 2}{Pc 1 + Pc 2} + γ \\ \begin{matrix}Pp 2 = \frac{Pc 1}{Pc 1 + Pc 2} - γ \\ where , \\ γ : straight movement priority \\ 0 \leq Pp 1 \leq 1 , 0 \leq Pp 2 \leq 1\end{matrix}\end{matrix} & ( 4 )\end{matrix}$$

<Collision Avoidance Course of Front Vehicle>

For a vehicle which is predicted by the avoidance-action vehicle prediction unit 105 to take a collision avoidance action, what course is to be taken as the collision avoidance course is calculated by the avoidance course calculation unit 106. In FIG. 7, a case is shown where the front vehicle 201 is predicted to take a collision avoidance action. The front vehicle 201 that will take a collision avoidance action is indicated by hatching.

In the collision expected lane Lpc in which the front vehicle 201 and the rear vehicle 202 as the possibly-colliding pair are traveling, a leading vehicle 206 is shown ahead of the front vehicle 201. In a left lane LL1 on the immediate left side of the collision expected lane Lpc, a leading vehicle 207 and a following vehicle 208 are shown ahead of and behind the front vehicle 201, respectively. Further, there are shown: a velocity V1 of the front vehicle 201; a velocity V2 of the rear vehicle 202; velocities V6, V7 of the leading vehicles 206, 207; a velocity V8 of the following vehicle 208; and inter-vehicle distances R12, R16, R17, R18.

An approaching velocity ΔV12 between the front vehicle 201 and the rear vehicle 202 is given as ΔV12=V2−V1. An approaching velocity ΔV16 between the front vehicle 201 and the leading vehicle 206 is given as ΔV16=V1−V6. An approaching velocity ΔV17 between the front vehicle 201 and the leading vehicle 207 with respect to the traveling direction is given as ΔV17=V1−V7. An approaching velocity ΔV18 between the front vehicle 201 and the following vehicle 208 with respect to the traveling direction is given as ΔV18=V8−V1.

Consideration will be made on a collision probability Pc3 in the case where the front vehicle 201 takes, as a collision avoidance course, the acceleration course that is “a course for increasing, by acceleration, an inter-vehicle distance to the rear vehicle”. When the front vehicle 201 keeps traveling in the collision expected lane Lpc, the probability of collision with the leading vehicle 206 is ΔV16/R16. When the front vehicle 201 keeps traveling in the collision expected lane Lpc, the probability of collision with the rear vehicle 202 is ΔV12/R12. Thus, when the front vehicle 201 keeps traveling in the collision expected lane Lpc, the collision probability Pc3 can be calculated as a sum of the above probabilities. Instead, the collision probability Pc3 may be calculated in such a manner that the higher one is selected from these probabilities.

Consideration will be made on a collision probability Pc4 in the case where the front vehicle 201 takes, as a collision avoidance course, the lane change course that is “a course for changing the lane in order to give way to the rear vehicle”. When the front vehicle 201 has changed the lane to the left lane LL1, the probability of collision with the leading vehicle 207 is ΔV17/R17. When the front vehicle 201 has changed the lane to the left lane LL1, the probability of collision with the following vehicle 208 is ΔV18/R18. Thus, when the front vehicle 201 has changed the lane to the left lane LL1, the collision probability Pc4 can be calculated as a sum of the above probabilities. Instead, the collision probability Pc4 may be calculated in such a manner that the higher one is selected from these probabilities.

Accordingly, the collision probability Pc3 of the front vehicle 201 in the case of taking the acceleration course, and the collision probability Pc4 of the front vehicle 201 in the case of taking the lane change course can be calculated by a following formula (5).

$$\begin{matrix}[ Mathematical 5 ] & \\ \{ \begin{matrix}Pc 3 = \frac{Δ V 12}{R 12} + \frac{Δ V 16}{R 16} \\ Pc 4 = \frac{Δ V 17}{R 17} + \frac{Δ V 18}{R 18} \\ where , \\ Δ V 12 = V 2 - V 1 , Δ V 16 = V 1 - V 6 , \\ Δ V 17 = V 1 - V 7 and Δ V 18 = V 8 - V 1\end{matrix} & ( 5 )\end{matrix}$$

For each of the collision probability Pc3 in the case of taking the acceleration course and the collision probability Pc4 in the case of taking the lane change course, a possibility index may be calculated on the basis of an inverse thereof. From the inverses of the collision probability Pc3 and the collision probability Pc4, an acceleration course possibility Pp3 that is a possibility of taking the acceleration course and a lane-change course possibility Pp4 that is a possibility of taking the lane change course, may be calculated. The relationships among them are represented by a following formula (6).

$$\begin{matrix}[ Mathematical 6 ] & \\ Pp 3 : Pp 4 = \frac{1}{P c 3} : \frac{1}{P c 4} & ( 6 )\end{matrix}$$

The acceleration course possibility Pp3 and the lane-change course possibility Pp4 are each a possibility index having a value of not less than 0 and not more than 1, and can be calculated by a following formula (7).

$$\begin{matrix}[ Mathematical 7 ] & \\ \{ \begin{matrix}Pp 3 = \frac{Pc 4}{Pc 3 + Pc 4} \\ Pp 4 = \frac{Pc 3}{Pc 3 + Pc 4}\end{matrix} & ( 7 )\end{matrix}$$

It can be determined that the front vehicle 201 will take a collision avoidance course according to either one of the acceleration course possibility Pp3 and the lane-change course possibility Pp4 having a possibility index higher than the other. In this manner, the avoidance course calculation unit 106 can calculate the collision avoidance course.

Similarly to the collision avoidance course of the rear vehicle 202, a restriction is applied to the value that the approaching speed ΔV has, assuming that no trouble occurs thereby in calculation. Namely, calculation is performed in such a manner that the approaching velocity is restricted by a maximum value and a minimum value as 0.1 [m/s]<ΔV<100 [m/s]. Likewise, a restriction is applied to the value that the inter-vehicle distance R has. Namely, calculation is performed in such a manner that the inter-vehicle distance is restricted by a maximum value and a minimum value as 0.1 [m] R 1000 [m].

When one of the leading vehicles 206, 207 and the following vehicle 208 is absent, calculation is performed for that target vehicle on the assumption of ΔV=0.1 [m/s] and R=1000 [m], similarly to the collision avoidance course of the rear vehicle 202. Accordingly, the influence weight of the target vehicle on the collision probability Pc is 0.0001 and thus, it is substantially not required to give consideration to a possibility of collision with the target vehicle.

In addition, with respect to the collision avoidance course of the front vehicle 201, it is conceivable that the front vehicle 201 is likely to stay in the currently-traveling collision expected lane Lpc and thus to give more priority to traveling in the same lane than to lane change. In this case, a straight movement priority γ may be defined (0≤γ≤1). With the addition of the straight movement priority γ, the acceleration course possibility Pp3 and the lane-change course possibility Pp4 of the front vehicle 201 can be calculated as represented by a following formula (8).

$$\begin{matrix}[ Mathematical 8 ] & \\ \{ \begin{matrix}Pp 3 = \frac{Pc 4}{Pc 3 + Pc 4} + γ \\ \begin{matrix}Pp 4 = \frac{Pc 3}{Pc 3 + Pc 4} - γ \\ where , \\ γ : straight movement priority \\ 0 \leq Pp 3 \leq 1 , 0 \leq Pp4 \leq 1\end{matrix}\end{matrix} & ( 8 )\end{matrix}$$

As described above, with respect to the rear vehicle 202, the avoidance course calculation unit 106 can calculate its collision avoidance course according to either one of the deceleration course possibility Pp1 and the lane-change course possibility Pp2 having a possibility index higher than the other. Further, with respect to the front vehicle 201, the avoidance course calculation unit 106 can calculate its collision avoidance course according to either one of the acceleration course possibility Pp3 and the lane-change course possibility Pp4 having a possibility index higher than the other.

So far, the description has been made on the collision probabilities Pc1, Pc2, Pc3, Pc4, the deceleration course possibility Pp1, the acceleration course possibility Pp3 and the lane-change course possibilities Pp2, Pp4. However, how to calculate the collision probability and the possibility of taking each course may not be limited to the foregoing methods. Any one of a variety of existing techniques as represented by a technique described in Patent Document of International Patent Application Publication No. 2015/156097 may be employed.

<Operations of Course Prediction Device (1)>

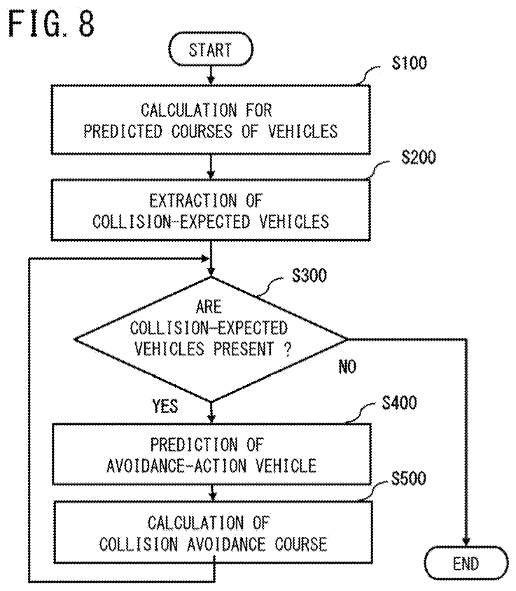

FIG. 8 is a flowchart showing operations of the course prediction device 100 according to Embodiment 1. The operations according to the flowchart of FIG. 8 are executed every fixed period of time (for example, every 10 ms). It is allowed that the operations according to the flowchart of FIG. 8 are not executed every fixed period of time but are executed at every occurrence of an event, such as, at every time the vehicle has traveled a fixed distance or at every time the vehicle information sensor 10 mounted on the vehicle detects vehicle information of another vehicle.

With the start of the operations according to the flowchart of FIG. 8, in Step S100, predicted courses of the respective vehicles are calculated. The predicted course calculation unit 103 calculates the predicted courses of the respective vehicles, on the basis of the current states (positions, velocities, etc.) of the host vehicle and the other vehicles that are detected by the vehicle information detection unit 101, and the road information acquired by the road information acquisition unit 102.

In Step S200, the collision-expected vehicle extraction unit 104 extracts a possibly-colliding pair. In Step S300, it is determined whether collision expected vehicles are present or not. If the possibly-colliding pair has been extracted, it is determined that collision expected vehicle are present (judgement is “YES”), and the flow moves to Step S400. If no possibly-colliding pair has been extracted, it is determined that collision expected vehicles are absent (judgement is “NO”), and the operations are terminated.

In Step S400, an avoidance action vehicle is predicted. The avoidance-action vehicle prediction unit 105 predicts which one of the front vehicle 201 and the rear vehicle 202 as the thus-extracted possibly-colliding pair, will take a collision avoidance action.

In Step S500, a collision avoidance course is calculated. The avoidance course calculation unit 106 calculates the collision avoidance course of the vehicle which is predicted by the avoidance-action vehicle prediction unit 105 to take a collision avoidance action. When multiple possibly-colliding pairs are present, the collision avoidance course is calculated for each of the possibly-colliding pairs. Calculations of the collision avoidance courses for the multiple possibly-colliding pairs are to be executed in any order. These calculations may be executed in descending order of possibility of collision of each possibly-colliding pair. Instead, these calculations may be executed in ascending order of closeness of location of each possibly-colliding pair to the host vehicle. Then, the flow moves to Step S200, to thereby execute extraction of other collision expected vehicles. This processing is repeated continuously until there is no pair of collision expected vehicles to be extracted.

The flowchart of FIG. 8 does not mention the transmission of the predicted courses by the predicted course transmission unit 107. The predicted course transmission unit 107 may transmit the predicted courses and the collision avoidance course/courses at every time the operations according to the flowchart of FIG. 8 are terminated. Instead, the course prediction device 100 may transmit the predicted courses and the collision avoidance course/courses when requested to transmit the predicted courses.

FIG. 9 is a flowchart showing a first example of operations of the avoidance-action vehicle prediction unit 105 in the course prediction device 100 according to Embodiment 1. In the flowchart of FIG. 9, details of Step S400 in the flowchart of FIG. 8 are described.

In Step S401 in FIG. 9, the front vehicle 201 and the rear vehicle 202 as a possibly-colliding pair are determined. The front vehicle 201 and the rear vehicle 202 are identified according to the on-road traveling direction of the host vehicle.

In Step S402, it is determined whether or not the collision expected lane Lpc in which the possibly-colliding pair are currently traveling is the rightmost lane of the road. If it is the rightmost lane (judgement is “YES”), the flow moves to Step S404. If it is not the rightmost lane (judgement is “NO”), the flow moves to Step S403. When it is not the rightmost lane, it is meant that a right lane LR1 is placed on the immediate right side of the collision expected lane Lpc.

In Step S403, it is determined that the rear vehicle 202 will take a collision avoidance action. Since the right lane LR1 is placed on the immediate right side of the collision expected lane Lpc, the rear vehicle 202 can change the lane in order to overtake the front vehicle 201. In general, when the inter-vehicle distance becomes shorter, the rear vehicle 202 initiatively causes a collision avoidance action in many cases. Since the rear vehicle 202 can change the lane to the overtaking lane, the rear vehicle 202 has flexibility to select the deceleration course or the lane change course. In this case, it can be predicted that the rear vehicle 202 will initiatively take a collision avoidance action. After execution of Step S403, the operations are terminated.

In Step S404, it is determined that the front vehicle 201 will take a collision avoidance action. Since the collision expected lane Lpc is the rightmost lane, the rear vehicle 202 cannot change the lane in order to overtake the front vehicle 201. Thus, the rear vehicle 202 is less flexible in selecting a collision avoidance action, so that it is less easy to take action. In this case, it is predicted that the front vehicle, which is more flexible in selecting a collision avoidance course, will take a collision avoidance action. After execution of Step S404, the operations are terminated.

<Example of Collision Avoidance Course (1)>

FIG. 10 is a diagram showing a collision avoidance course of a vehicle in the rightmost lane, according to Embodiment 1. This diagram is a specific example corresponding to a case where the collision expected lane Lpc in which the possibly-colliding pair are currently traveling is the rightmost lane of a road. Since the collision expected lane Lpc is the rightmost lane, the rear vehicle 202 cannot change the lane in order to overtake the front vehicle 201.

The rear vehicle 202 is less flexible in selecting a collision avoidance action, so that it is less easy to take action. In this case, the front vehicle 201, which is more flexible in selecting a collision avoidance course, will take a collision avoidance action. In FIG. 10, a case is shown where the front vehicle 201 takes the lane change course Tlc.

<Operations of Course Prediction Device (2)>

FIG. 11 is a flowchart showing a second example of operations of the avoidance-action vehicle prediction unit 105 in the course prediction device 100 according to Embodiment 1. In the flowchart of FIG. 11, details of Step S400 in the flowchart of FIG. 8 are described.

The flowchart of FIG. 11 differs from the flowchart of FIG. 9 in that Step S408 and Step S409 are inserted between Step S402 and Step S403. The portion of FIG. 11 except for this difference is the same as FIG. 9 and thus, description thereof is omitted here.

In Step S402 in FIG. 11, it is determined whether or not the collision expected lane Lpc is the rightmost lane of the road. If it is the rightmost lane (judgement is “YES”), like in FIG. 9, the flow moves to Step S404. If it is not the rightmost lane (judgement is “NO”), the flow moves to Step S408.

In Step S408, it is determined whether or not the collision expected lane Lpc is the leftmost lane of the road. If it is the leftmost lane (judgement is “YES”), the flow moves to Step S403. When the collision expected lane Lpc is the leftmost lane of the road, the front vehicle 201 cannot change the lane to the left side to thereby keep away from the approaching rear vehicle, so that the number of choices for collision avoidance action of the front vehicle is decreased. Thus, it is predicted that the rear vehicle 202 will take a collision avoidance action.

When, in Step S408, the collision expected lane Lpc is determined not to be the leftmost lane of the road (judgement is “NO”), the flow moves to Step S409. This corresponds to a case where other lanes are placed on both sides of the collision expected lane Lpc. In Step S409, it is determined whether or not the number of lanes on the left side is not more than the number of lanes on the right side. When the number of lanes on the left side is not more than the number of lanes on the right side (judgement is “YES”), the flow moves to Step S403.

This is because, it is determined that the rear vehicle 202 having a possibility of collision avoidance to the right lane, will take a collision avoidance action. In general, when the number of lanes on the right side and the number of lanes on the left side are the same, since a lane change by the rear vehicle 202 for overtaking is taken more frequently than a lane change by the front vehicle 201 for giving passageway, it is determined that a collision avoidance action will be taken by the rear vehicle 202.

When, in Step S409, the number of lanes on the left side is determined to be more than the number of lanes on the right side (judgement is “NO”), the flow moves to Step S404. This is because, since the number of lanes on the left side of the collision expected lane Lpc is larger, it is determined that the front vehicle 201 having a possibility of collision avoidance to the left lane will take a collision avoidance action. This determination is based on a thought that a lane change is more likely to be taken to the side with a larger number of lanes than to the other side.

<Example of Collision Avoidance Course (2)>

FIG. 12 is a diagram showing a collision avoidance course of a vehicle in the leftmost lane, according to the operations of the flowchart of FIG. 11 in Embodiment 1. This diagram is a specific example corresponding to a case where the collision expected lane Lpc in which the possibly-colliding pair are currently traveling is the leftmost lane of a road. Since the collision expected lane Lpc is the leftmost lane, the front vehicle 201 cannot change the lane in order to give passageway to the rear vehicle 202.

The front vehicle 201 is less flexible in selecting a collision avoidance action, so that it is less easy to take action and thus, it can be predicted that the rear vehicle 202, which is more flexible in selecting a collision avoidance course, will take a collision avoidance action. In FIG. 12, a case is shown where the rear vehicle 202 selects the lane change course Tlc.

<Example of Collision Avoidance Course (3)>

FIG. 13 is a diagram showing a collision avoidance course of a vehicle in a center lane, according to the operations of the flowchart of FIG. 11 in Embodiment 1. This diagram corresponds to a case where other lanes are placed on both sides of the collision expected lane Lpc. It is determined whether or not the number of lanes on the left side is not more than the number of lanes on the right side. In the illustrated case, since the number of lanes on the left side and the number of lanes on the right side are each one and thus the same, it is predicted that the rear vehicle 202 will take a collision avoidance action. In FIG. 13, a case is shown where the rear vehicle 202 selects the lane change course Tlc.

According to the flowcharts shown in FIG. 9 and FIG. 11, in the case where it is difficult to determine whether the front vehicle 201 or the rear vehicle 202 is the vehicle that will take a collision avoidance action, the avoidance-action vehicle prediction unit 105 predicts that the rear vehicle will take a collision avoidance action. In that case, however, the prediction unit may predict that the front vehicle is the vehicle that will take a collision avoidance action.

Further, according to the flowcharts shown in FIG. 9 and FIG. 11, the determination method is based on traffic regulations or customs in a region in which the overtaking lane is on the right side. However, in order to actualize another determination method based on traffic regulations or customs in a region other than Japan, England, etc., in which the overtaking lane is on the left side, the conditions for determination may be exchanged between the right and left sides.

In the foregoing description, whether the vehicle that will take a collision avoidance action is the front vehicle 201 or the rear vehicle 202, is predicted on the basis of whether the collision expected lane Lpc is the rightmost lane or the leftmost lane of a road. Further, when other lanes are placed on both sides of the collision expected lane Lpc, whether the vehicle that will take a collision avoidance action is the front vehicle 201 or the rear vehicle 202 is predicted on the basis of the magnitude relationship between the number of lanes on the left side and the number of lanes on the right side. However, the vehicle that will take a collision avoidance action may be predicted by comparing the respective collision probabilities shown in the formulas (1), (5) while referring to FIGS. 6 and 7,

The collision probability Pc1 in the case where the rear vehicle 202 takes the deceleration course, the collision probability Pc2 in the case where the rear vehicle 202 takes the lane change course for overtaking, the collision probability Pc3 in the case where the front vehicle 201 takes the acceleration course, and the collision probability Pc4 in the case where the front vehicle 201 takes the lane change course for giving way, may be compared with each other to thereby predict that the collision avoidance course with the least collision probability will be taken. This makes it possible to predict whether the vehicle that will take a collision avoidance action is the front vehicle 201 or the rear vehicle 202, and also to predict the collision avoidance course to be selected.

Furthermore, the vehicle that will take a collision avoidance action and its collision avoidance course may be predicted in such a manner that unadoptable courses are excluded on the basis of whether the collision expected lane Lpc is the rightmost lane or the leftmost lane of the road, in addition to the collision probabilities Pc1, Pc2, Pc3, Pc4 calculated as described above. Further, when other lanes are placed on both sides of the collision expected lane Lpc, the vehicle that will take a collision avoidance action and its collision avoidance course may be predicted in such a manner that modification is made to the collision probabilities Pc1, Pc2, Pc3, Pc4 calculated as described above, on the basis of the magnitude relationship between the number of lanes on the left side and the number of lanes on the right side.

According to the course prediction device 100 configured as described above, with respect to two vehicles which are traveling in the same lane, it is possible to predict which one of a situation in which the front vehicle 201 takes a collision avoidance action and a situation in which the rear vehicle 202 takes a collision avoidance action, is likely to occur. Accordingly, in comparison with the conventional technique of predicting only a collision avoidance action of the rear vehicle 202 in two vehicles, it is possible to improve the prediction accuracy of the traveling states of nearby vehicles.

### 2. Embodiment 2

A course prediction device 100 according to Embodiment 2 will be described with reference to figures. Description will be firstly made on such a possibility that, when two other vehicles which are traveling in the same lane are extracted as a possibly-colliding pair, one of them takes a collision avoidance action of changing the lane to enter a host vehicle's lane in which the host vehicle is traveling.

When the other vehicle changes the lane to the host vehicle's lane in which the host vehicle is traveling, in some cases, it is required in response to that action, to promptly take action. In consideration of an influence caused by the entering of the other vehicle into the host vehicle's lane, it is important to make ready for that action.

The course prediction device 100 according to Embodiment 2 includes an avoidance-action vehicle prediction unit 105 that can preferentially predict the entering of another vehicle into the host vehicle's lane, as the action of the other vehicle. Since the lane change of the other vehicle to the host vehicle's lane is predicted preferentially, it is possible to reduce the frequency of missing the action of the other vehicle entering the host vehicle's lane.

The configuration diagram of the course prediction device 100 according to Embodiment 2 is similar to that of Embodiment 1 and is shown also by FIG. 1. The hardware configuration of the course prediction device 100 according to Embodiment 2 is similar to that of Embodiment 1 and is shown also by FIG. 2.

<Operations of Course Prediction Device (1)>

The flowchart showing operations of the course prediction device 100 according to Embodiment 2 is similar to that of Embodiment 1 and is shown also by FIG. 8. FIG. 14 is a flowchart showing a first example of operations of the avoidance-action vehicle prediction unit 105 in the course prediction device 100 according to Embodiment 2. The flowchart of FIG. 14 shows details of Step S400 in FIG. 8. The flowchart of FIG. 14 differs from the flowchart of FIG. 9 according to Embodiment 1 in that Step S405 is inserted between Step S401 and Step S402. The portion of FIG. 14 except for this difference is the same as FIG. 9 and thus, description thereof is omitted here.

In Step S405 in FIG. 14, it is determined whether or not the collision expected lane Lpc is on the right side of a host vehicle's lane LS (written as “Host Traffic Lane” in “Step S405”). If the collision expected lane Lpc is on the right side of the host vehicle's lane LS (judgement is “YES”), the flow moves to Step S404.

In Step S404, such a situation is preferentially assumed in which one of the other vehicles extracted as a possibly-colliding pair takes a collision avoidance action directed to the host vehicle's lane LS. In the illustrated case, the avoidance-action vehicle prediction unit 105 predicts that the front vehicle 201 which may possibly take a collision avoidance action directed to the host vehicle's lane LS, will be the avoidance action vehicle. After Step S404, the operations are terminated.

If, in Step S405, the collision expected lane Lpc is determined not to be on the right side of the host vehicle's lane LS (judgement is “NO”), the flow moves to Step S402. Operations in and subsequent to Step S402 are the same as those in FIG. 9.

<Example of Collision Avoidance Course (1)>

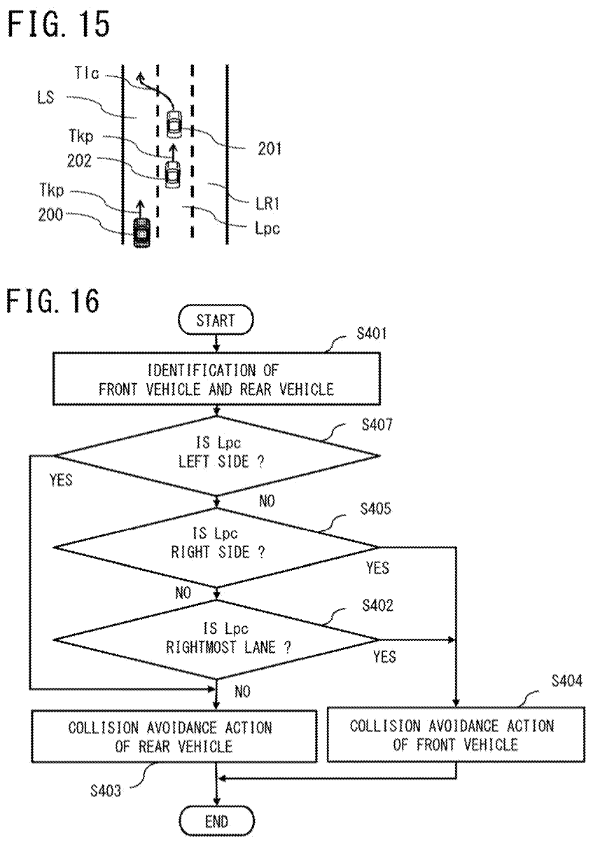

FIG. 15 is a first diagram showing a collision avoidance course of a vehicle, according to Embodiment 2. A host vehicle 200 is indicated by hatching. On the right side of the host vehicle's lane LS in which the host vehicle 200 is traveling, the collision expected lane Lpc is placed in which the front vehicle 201 and the rear vehicle 202 are traveling. In this case, the avoidance-action vehicle prediction unit 105 predicts that, out of the front vehicle 201 and the rear vehicle 202, the front vehicle 201 which may possibly take a collision avoidance action directed to the host vehicle's lane LS, will take the collision avoidance action.

In FIG. 15, such a situation is shown in which, in response to the approach of the rear vehicle 202, the front vehicle 201 takes the lane change course Tlc for giving the lane, to thereby avoid making contact with the rear vehicle. On the ground of possibility that the front vehicle 201 takes the collision avoidance action directed to the host vehicle's lane LS, the avoidance-action vehicle prediction unit 105 predicts the avoidance action vehicle. By the course prediction device 100 according to Embodiment 2, it is possible to make ready for an abnormal approach of an avoidance action vehicle to the host vehicle, on the ground of possibility that the front vehicle 201 takes the collision avoidance action directed to the host vehicle's lane LS.

<Operations of Course Prediction Device (2)>

FIG. 16 is a flowchart showing a second example of operations of the avoidance-action vehicle prediction unit 105 in the course prediction device 100 according to Embodiment 2. The flowchart of FIG. 16 differs from the flowchart of FIG. 14 in that Step S407 is inserted between Step S401 and Step S405. The portion of FIG. 16 except for this difference is the same as FIG. 14 and thus, description thereof is omitted here.

In Step S407 in FIG. 16, it is determined whether or not the collision expected lane Lpc is on the left side of a host vehicle's lane LS (written as “Host Traffic Lane” in “Step S407”). If the collision expected lane Lpc is on the left side of the host vehicle's lane LS (judgement is “YES”), the flow moves to Step S403 and thus, the rear vehicle 202 is determined to be the avoidance action vehicle. Here, such a situation is preferentially assumed in which, out of the other vehicles extracted as a possibly-colliding pair, the rear vehicle takes the collision avoidance action directed to the host vehicle's lane LS.

If, in Step S407, the collision expected lane Lpc is determined not to be on the left side of the host vehicle's lane LS (judgement is “NO”), the flow moves to Step S405. The following operations are similar to those in the flowchart of FIG. 14.

<Example of Collision Avoidance Course (2)>

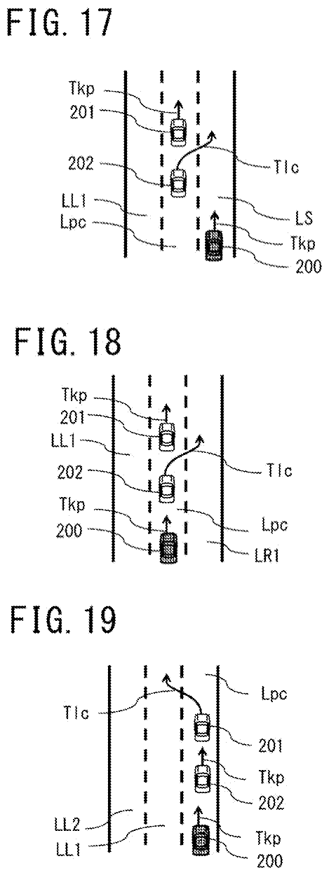

FIG. 17 is a second diagram showing a collision avoidance course of a vehicle, according to the operations in the flowchart of FIG. 16 of Embodiment 2. A host vehicle 200 is indicated by hatching. On the left side of the host vehicle's lane LS in which the host vehicle 200 is traveling, the collision expected lane Lpc is placed in which the front vehicle 201 and the rear vehicle 202 are traveling. In this case, the avoidance-action vehicle prediction unit 105 predicts that, out of the front vehicle 201 and the rear vehicle 202, the rear vehicle 202 which may possibly take the collision avoidance action directed to the host vehicle's lane LS, will take the collision avoidance action.

In FIG. 17, such a situation is shown in which, in response to the approach of the rear vehicle 202 to the front vehicle 201, the rear vehicle takes the lane change course Tlc for overtaking, to thereby avoid making contact with the front vehicle. On the ground of possibility that the rear vehicle 202 takes the collision avoidance action directed to the host vehicle's lane LS, the avoidance-action vehicle prediction unit 105 predicts the avoidance action vehicle. By the course prediction device 100 according to Embodiment 2, it is possible to make ready for an abnormal approach of an avoidance action vehicle to the host vehicle, on the ground of possibility that the rear vehicle 202 takes the collision avoidance action directed to the host vehicle's lane LS.

<Example of Collision Avoidance Course (3)>

FIG. 18 is a third diagram showing a collision avoidance course of a vehicle, according to Embodiment 2. A host vehicle 200 is indicated by hatching. There is shown a case where the host vehicle's lane in which the host vehicle 200 is traveling and the collision expected lane Lpc in which the front vehicle 201 and the rear vehicle 202 are traveling, are the same.

In this case, the avoidance-action vehicle prediction unit 105 predicts that, out of the front vehicle 201 and the rear vehicle 202, the rear vehicle 202 will take a collision avoidance action. In general, a lane change by the rear vehicle for overtaking, is taken more frequent than a lane change by the front vehicle for giving passageway, so that it is determined that a collision avoidance action will be taken by the rear vehicle.

<Example of Collision Avoidance Course (4)>

FIG. 19 is a fourth diagram showing a collision avoidance course of a vehicle, according to Embodiment 2. A host vehicle 200 is indicated by hatching. There is shown a case where the host vehicle's lane in which the host vehicle 200 is traveling and the collision expected lane Lpc in which the front vehicle 201 and the rear vehicle 202 are traveling, are the same. There is also shown a case where the collision expected lane Lpc is a rightmost lane.

When another travelable lane is not placed on the immediate right side of the collision expected lane Lpc, the rear vehicle 202 cannot select the collision avoidance action of changing the lane for overtaking. Since the choices for collision avoidance course of the rear vehicle 202 are thus restricted, the avoidance-action vehicle prediction unit 105 predicts that the front vehicle 201 which has many choices for collision avoidance action will take a collision avoidance action.

As described above, the course prediction device 100 according to Embodiment 2 has been explained. The avoidance-action vehicle prediction unit 105 predicts, out of the possibly-colliding pair, the vehicle that will take a collision avoidance action for avoiding collision, on the basis of the host vehicle's lane. Since the lane change of the other vehicle to the host vehicle's lane is predicted preferentially, it is possible to reduce the frequency of missing the action of the other vehicle entering the host vehicle's lane.

### 3. Embodiment 3

In a course prediction device 100 according to Embodiment 3, with respect to the vehicles in a possibly-colliding pair, their respective collision avoidance courses are calculated. Then, new collision expected vehicles are extracted which will emerge after the above respective collision avoidance courses are taken, and then a possibility of collision therebetween is evaluated. According to this result, the avoidance-action vehicle prediction unit 105 predicts which one of the collision avoidance courses will be taken.

Accordingly, it is possible to predict the vehicle that will take a collision avoidance action, in consideration of the presence of vehicles nearby the possibly-colliding pair. As a result, it is possible to reduce the frequency of occurrence of erroneous prediction as represented by a case where such a collision avoidance action is predicted that will cause excessive approach to another vehicle.

<Configuration of Course Prediction Device>

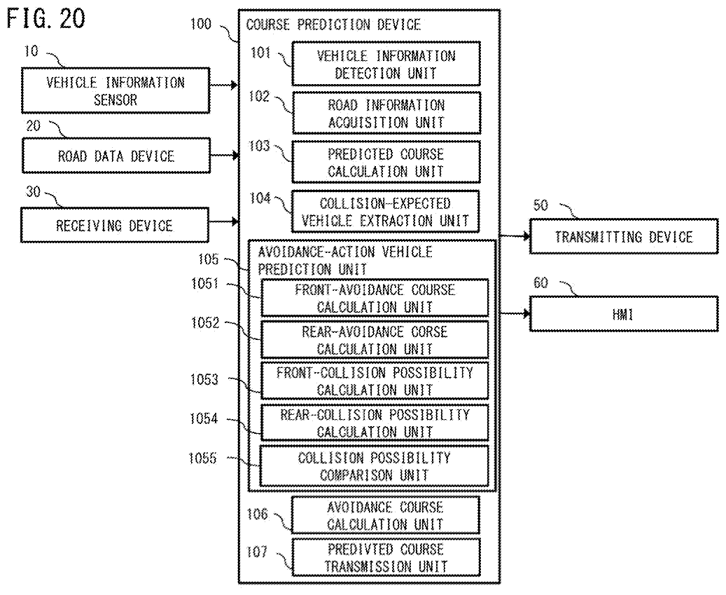

FIG. 20 is a configuration diagram of the course prediction device 100 according to Embodiment 3. The configuration diagram differs from the configuration diagram of FIG. 1 according to Embodiment 1 in that a front-avoidance course calculation unit 1051, a rear-avoidance course calculation unit 1052, a front-collision possibility calculation unit 1053, a rear-collision possibility calculation unit 1054 and a collision possibility comparison unit 1055, are provided in the avoidance-action vehicle prediction unit 105.

Since the difference only resides in the addition of functions of the avoidance-action vehicle prediction unit 105, the reference numerals of the course prediction device 100 and the avoidance-action vehicle prediction unit 105 are each kept the same. Further, FIG. 2 according to Embodiment 1 can be applied to the hardware configuration of the course prediction device 100.

In the course prediction device 100 according to Embodiment 3, the avoidance-action vehicle prediction unit 105 verifies a situation assumed when the front vehicle 201 and the rear vehicle 202 extracted by the collision-expected vehicle extraction unit 104 take their respective collision avoidance actions. It causes the front-avoidance course calculation unit 1051 to calculate a front avoidance course that is a collision avoidance course of the front vehicle 201. Further, it causes the rear-avoidance course calculation unit 1052 to calculate a rear avoidance course that is a collision avoidance course of the rear vehicle 202.

The avoidance-action vehicle prediction unit 105 causes the front-collision possibility calculation unit 1053 to calculate on the basis of the road information, the predicted courses and the front avoidance course: a second front vehicle and a second rear vehicle which are expected to be on the same lane and which may possibly cause collision therebetween; and a front avoidance-caused collision possibility that is a possibility of that collision. The avoidance-action vehicle prediction unit 105 causes the rear-collision possibility calculation unit 1054 to calculate on the basis of the road information, the predicted courses and the rear avoidance course: a third front vehicle and a third rear vehicle which are expected to be on the same lane and which may possibly cause collision therebetween; and a rear avoidance-caused collision possibility that is a possibility of that collision.

The avoidance-action vehicle prediction unit 105 causes the collision possibility comparison unit 1055 to compare the front avoidance-caused collision possibility with the rear avoidance-caused collision possibility. The avoidance-action vehicle prediction unit 105 predicts that the vehicle which may possibly take the collision avoidance action corresponding to one of the above possibilities that is lower than the other one, is the avoidance action vehicle.

With the configuration thus-described, it is possible to prevent erroneous prediction as represented by a case where, as the result of a collision avoidance action taken by a vehicle, after said vehicle moves to the collision avoidance course, a new possibly-colliding pair emerges and the possibility of collision therebetween is high. This makes it possible to improve the prediction accuracy of the traveling states of nearby vehicles.

In FIG. 20, the avoidance-action vehicle prediction unit 105 has a configuration in which the functional blocks 1051 to 1055 are added. The functions of them are partly overlapped with the functions of the predicted course calculation unit 103, the collision-expected vehicle extraction unit 104 and the avoidance course calculation unit 106. These functions may be commoditized to thereby effectively utilize such resources. It is also allowed to invoke from the avoidance-action vehicle prediction unit 105, some functions of the predicted course calculation unit 103, the collision-expected vehicle extraction unit 104 and the avoidance course calculation unit 106, and then to activate these functions for the above calculations.

<Operations of Course Prediction Device>

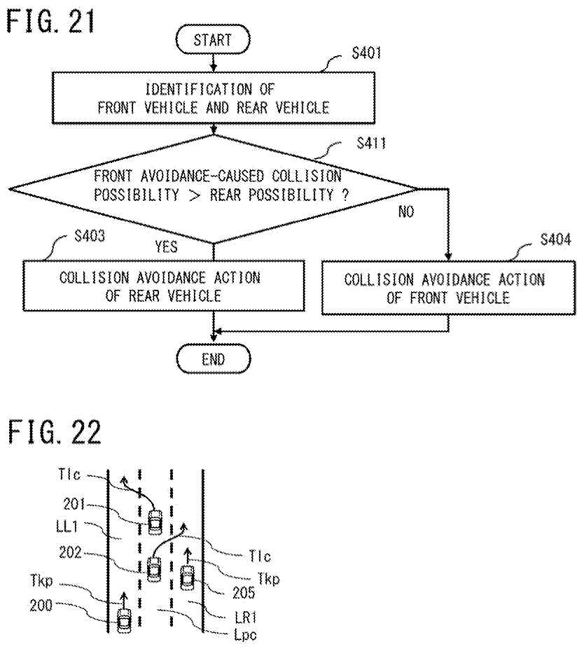

The flowchart showing operations of the course prediction device 100 according to Embodiment 3 is similar to that of Embodiment 1 and is shown also by FIG. 8. FIG. 21 is a flowchart showing an example of operations of the avoidance-action vehicle prediction unit 105 in the course prediction device 100 according to Embodiment 3. The flowchart of FIG. 21 shows details of Step S400 in FIG. 8.

The flowchart of FIG. 21 differs from the flowchart of FIG. 9 according to Embodiment 1 in that Step S402 is replaced with Step S411. The portion of FIG. 21 except for this difference is the same as FIG. 9 and thus, description thereof is omitted here.

In Step S411 in FIG. 21, the avoidance-action vehicle prediction unit 105 calculates the front avoidance-caused collision possibility and the rear avoidance-caused collision possibility which are expected when the front vehicle 201 and the rear vehicle 202 takes their respective collision avoidance actions, and compares these possibilities with each other. When the front avoidance-caused collision possibility is higher than the rear avoidance-caused collision possibility (judgment is “YES”), the flow moves to Step S403 and thus, it is predicted that the rear vehicle 202 will take a collision avoidance action. When the front avoidance-caused collision possibility is not higher than the rear avoidance-caused collision possibility (judgment is “NO”), the flow moves to Step S404 and thus, it is predicted that the front vehicle 201 will take a collision avoidance action.

<Example of Collision Avoidance Course>

FIG. 22 is a diagram for illustrating a possibility of collision caused by a collision-avoidance course of a vehicle, according to Embodiment 3. Here, a case is shown where the lane change course Tlc directed to a left lane LL1 is assumed to be selected for the front vehicle 201 and the lane change course Tlc directed to a right lane LR1 is assumed to be selected for the rear vehicle 202.

Other than the front vehicle 201 and the rear vehicle 202 which are traveling in the collision expected lane Lpc, on the rear side of them, a host vehicle 200 is traveling in the left lane LL1. On the rear side, a following vehicle 205 is traveling in the right lane LR1.

There is shown a situation in which the following vehicle 205 in the right lane LR1 is traveling near the rear vehicle 202. The lane change course Tlc of the front vehicle 201 is calculated by the front-avoidance course calculation unit 1051. The lane change course Tlc of the front vehicle 201 is a course for changing the lane to the left side in order to give way to the rear vehicle 202.

The lane change course Tlc of the rear vehicle 202 is calculated by the rear-avoidance course calculation unit 1052. The lane change course Tlc of the rear vehicle 202 is a course for changing the lane to the right side in order to overtake the front vehicle 201 to thereby avoid collision therewith.

With respect to the respective avoidance courses, possibilities of collision are calculated by the front-collision possibility calculation unit 1053 and the rear-collision possibility calculation unit 1054. In the situation of FIG. 22, the possibility of collision between the following vehicle 205 and the rear vehicle 202 after moving to the collision avoidance course, seems to be high. By the collision possibility comparison unit 1055, the possibilities of collision are mutually compared and it is determined that the possibility of collision caused by the collision avoidance course of the rear vehicle 202 is higher than the other possibility, so that it is predicted by the avoidance-action vehicle prediction unit 105, that the collision avoidance course of the front vehicle 201 will be taken.

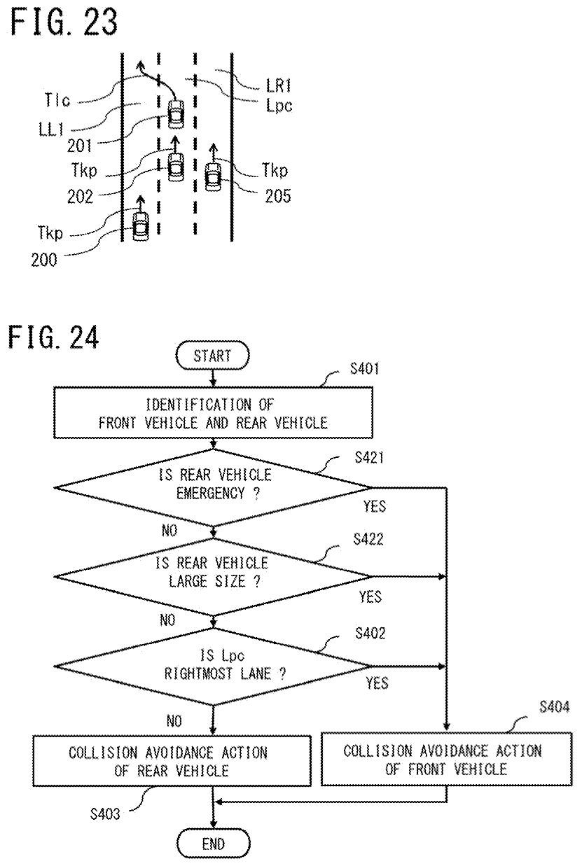

FIG. 23 is a diagram showing a collision avoidance course of a vehicle, according to Embodiment 3. Here, such a result is shown in which only the lane change course Tlc of the front vehicle 201 which has been predicted to be the avoidance action vehicle, is left as a predicted course by the avoidance-action vehicle prediction unit 105. In FIG. 23, the lane change course Tlc to the left side taken by the front vehicle 201 is distant from the host vehicle 200. Thus, it is determined that the possibility index of the lane change course Tlc of the rear vehicle 202 is lower than the possibility index of the lane change course Tlc of the front vehicle 201.

The collision avoidance course of the front vehicle 201 is left as a prediction value while the collision avoidance course of the rear vehicle 202 is removed from prediction values. As a result, the lane change course Tlc shown in FIG. 23 is predicted. In this manner, as shown in FIG. 23, lane change-related prediction is established according to the thought of “The farther the lane-changeable vehicle is located from another vehicle, the higher the possibility of changing the lane”. When the vehicles of the possibly-colliding pair each can change the lane to the right and left sides, it is possible to suppress a collision avoidance course that will cause excessive approach to another vehicle from being predicted, and this makes it possible to reduce the frequency of occurrence of erroneous prediction.

### 4. Embodiment 4

In Embodiment 1, the description has been made on a case where the course prediction device 100 predicts a vehicle that will take a collision avoidance action, depending on whether a travelable lane is placed on the right side or the left side of the collision expected lane Lpc in which the possibly-colliding pair are traveling. The avoidance-action vehicle prediction unit 105 predicts which one of the front vehicle 201 and the rear vehicle 202 will take a collision avoidance action.

However, the frequency of performing the lane change actually varies depending on the attribution of the vehicle (identification of a compact vehicle, a medium-size vehicle, a large-size vehicle, an emergency vehicle or the like), or the like. For example, as compared with an ordinally vehicle, a large-size vehicle such as a trailer vehicle is more likely to cause an action for giving way to the rear vehicle. For further example, with respect to an emergency vehicle such as an ambulance vehicle or the like, a vehicle ahead of the emergency vehicle is likely to cause an action for giving way. In such cases, according to the course prediction device 100 of Embodiment 1, the frequency of occurrence of erroneous prediction about a lane-change action may be increased.

The course prediction device 100 according to Embodiment 4 includes an avoidance-action vehicle prediction unit 105 for predicting a vehicle that will take a collision avoidance action, on the basis of the attribution of a vehicle. Here, vehicle attribution data is assumed to be data indicative of: the vehicle type and the size of each of the host vehicle and the other vehicles; and whether it is an emergency vehicle or not; and the like. Examples of the emergency vehicle include a fire truck, an ambulance vehicle, a police vehicle, a self-defense force vehicle, patrol cars of a public highway corporation, a gas supplier, a power supplier and the like, and a private emergency vehicle, etc. The vehicle attribution data is detected by the vehicle information detection unit 101 on the basis of the signals received from the vehicle information sensor 10 or the receiving device 30, or both of them. This configuration makes it possible to reduce the frequency of occurrence of erroneous action-prediction about a lane-change action, in a situation in which a large-size vehicle, an emergency vehicle or the like is traveling.

The configuration diagram of the course prediction device 100 according to Embodiment 4 is similar to that of Embodiment 1 and is shown also by FIG. 1. The hardware configuration of the course prediction device 100 according to Embodiment 4 is similar to that of Embodiment 1 and is shown also by FIG. 2.

<Operations of Course Prediction Device>

The flowchart showing operations of the course prediction device 100 according to Embodiment 4 is similar to that of Embodiment 1 and is shown also by FIG. 8. FIG. 24 is a flowchart showing an example of operations of the avoidance-action vehicle prediction unit 105 in the course prediction device 100 according to Embodiment 4. The flowchart of FIG. 24 shows details of Step S400 in FIG. 8. The flowchart of FIG. 24 differs from the flowchart of FIG. 9 according to Embodiment 1 in that Step S421 and Step S422 are inserted between Step S401 and Step S402. The portion of FIG. 24 except for this difference is the same as FIG. 9 and thus, description thereof is omitted here.

In Step S421 in FIG. 24, it is determined whether or not the rear vehicle 202 is an emergency vehicle. If it is an emergency vehicle (judgement is “YES”), the flow moves to Step S404 and thus, it is predicted that the front vehicle 201 will take a collision avoidance action. This is because, in many cases, the front vehicle gives the lane to the emergency vehicle to thereby avoid collision when the emergency vehicle comes close thereto from the rear side. If it is not an emergency vehicle (judgement is “NO”), the flow moves to Step S422.

In Step S422 in FIG. 24, it is determined whether or not the rear vehicle 202 is a large-size vehicle. If it is a large-size vehicle (judgement is “YES”), the flow moves to Step S404 and thus, it is predicted that the front vehicle 201 will take a collision avoidance action. This is because, in many cases, the front vehicle gives the lane to the large-size vehicle to avoid collision when the large-size vehicle comes close thereto from the rear side. If it is not a large-size vehicle (judgement is “NO”), the flow moves to Step S402.

In this manner, it is possible to predict a vehicle that will take a collision avoidance action, according to the attribution of a vehicle. This makes it possible to reduce the frequency of occurrence of erroneous prediction about a collision avoidance action of another vehicle for an emergency vehicle or a large-size vehicle. Accordingly, the prediction accuracy of the traveling states of the nearby vehicles can be improved.

In this application, a variety of exemplary embodiments and examples are described; however, every characteristic, configuration or function that is described in one or more embodiments, is not limited to being applied to a specific embodiment, and may be applied singularly or in any of various combinations thereof to another embodiment. Accordingly, an infinite number of modified examples that are not exemplified here are supposed within the technical scope disclosed in the present description. For example, such cases shall be included where at least one configuration element is modified; where any configuration element is added or omitted; and furthermore, where at least one configuration element is extracted and combined with a configuration element of another embodiment.

1. A course prediction device, comprising:
a vehicle information detector for detecting positions and velocities of multiple vehicles;
a road information acquisitor for acquiring road information indicative of positions of lanes in a road on which the vehicles are traveling;
a predicted course calculator for calculating a predicted course of each of the vehicles that is a future traveling course thereof;
a collision-expected vehicle extractor for extracting, from the vehicles, a front vehicle and a rear vehicle on a same lane in said lanes that may possibly collide with each other, on a basis of the road information acquired by the road information acquisitor and the predicted courses calculated by the predicted course calculator;
an avoidance-action vehicle predictor for predicting which one of the front and rear vehicles extracted by the collision-expected vehicle extractor is an avoidance action vehicle that will take a collision avoidance action, on the basis of the road information and the predicted courses; and
an avoidance course calculator for calculating a collision avoidance course of the avoidance action vehicle predicted by the avoidance-action vehicle predictor.

2. The course prediction device of claim 1, wherein the avoidance-action vehicle predictor predicts that the front vehicle will take a collision avoidance action, when a collision expected lane that is the lane in which the front and rear vehicles extracted by the collision-expected vehicle extractor are traveling is an edge lane on an overtaking lane side, and predicts that the rear vehicle will take a collision avoidance action, when the collision expected lane is an edge lane on an overtaking lane opposite side which is an opposite side to the overtaking lane side.

3. The course prediction device of claim 1, wherein the avoidance-action vehicle predictor predicts that the rear vehicle will take a collision avoidance action, when there are other lanes on both sides of the lane in which the front and rear vehicles extracted by the collision-expected vehicle extractor are traveling.

4. The course prediction device of claim 1, wherein, in a case where there is a difference between respective numbers of lanes located on both sides of a collision expected lane that is the lane in which the front and rear vehicles extracted by the collision-expected vehicle extractor are traveling, the avoidance-action vehicle predictor predicts that the rear vehicle will take a collision avoidance action, when the number of the lanes on an overtaking lane side of the collision expected lane is equal to or more than the number of the lanes on an overtaking lane opposite side thereof, and predicts that the front vehicle will take a collision avoidance action, when the number of the lanes on the overtaking lane side of the collision expected lane is less than the number of the lanes on the overtaking lane opposite side thereof.

5. The course prediction device of claim 1, wherein the avoidance-action vehicle predictor predicts which one of the front and rear vehicles is the vehicle that will take a collision avoidance action, on a basis of relative positions of: the lane in which the front and rear vehicles extracted from the vehicles other than a host vehicle by the collision-expected vehicle extractor are traveling; and the lane in which the host vehicle is traveling.

6. The course prediction device of claim 1, wherein the avoidance-action vehicle predictor predicts that the front vehicle will take a collision avoidance action, when the lane in which the front and rear vehicles extracted from the vehicles other than a host vehicle by the collision-expected vehicle extractor are traveling, is located on an adjacent overtaking lane side of the lane in which the host vehicle is traveling.

7. The course prediction device of claim 1, wherein the avoidance-action vehicle predictor predicts that the rear vehicle will take a collision avoidance action, when the lane in which the front and rear vehicles extracted from the vehicles other than a host vehicle by the collision-expected vehicle extractor are traveling, is located on an adjacent overtaking lane opposite side of the lane in which the host vehicle is traveling.

8. The course prediction device of claim 1, wherein the avoidance-action vehicle predictor performs:
calculating a front avoidance course and a rear avoidance course that are respective collision avoidance courses presumed if the front and rear vehicles extracted by the collision-expected vehicle extractor both take collision avoidance actions;
calculating, on a basis of the road information, the predicted courses and the front avoidance course, a second front vehicle and a second rear vehicle on a same lane in said lanes that may possibly collide with each other, as well as a front avoidance-caused collision possibility that is a possibility of collision there-between;
calculating, on the basis of the road information, the predicted courses and the rear avoidance course, a third front vehicle and a third rear vehicle on a same lane in said lanes that may possibly collide with each other, as well as a rear avoidance-caused collision possibility that is a possibility of collision there-between; and
comparing the front avoidance-caused collision possibility with the rear avoidance-caused collision possibility, to thereby predict which one of the front and rear vehicles is the avoidance action vehicle that will take a collision avoidance action.

9. The course prediction device of claim 1, wherein the avoidance-action vehicle predictor predicts the vehicle that will take a collision avoidance action, on a basis of attributions of the front and rear vehicles extracted by the collision-expected vehicle extractor.
